(19) United States
(12) Patent Application Publication
(10) Pub. No.: US 2011/0197666 A1
(43) Pub. Date: Aug. 18, 2011

(54) Pressure Measuring Glow Plug

(76) Inventors: Yue Cheng, Shenyang/Liaoning (CN); Martin Allgaier, Ludwigsburg (DE)

(21) Appl. No.: 12/989,055

(22) PCT Filed: Apr. 21, 2009
(86) PCT No.: PCT/EP2009/002900

§ 371 Date: Feb. 16, 2011

(30) Foreign Application Priority Data
Apr. 23, 2008 (DE) 10 2008 020 509.5

(51) Int. Cl. G01M 15/08; B23K 1/20

(52) U.S. Cl. 73/114.19; 228/203

(57) ABSTRACT

The invention relates to a device for determining the combustion chamber pressure. The device includes a tubular base, a glow filament which projects from the tubular base, and at least one sensor element arranged in the tubular base. The invention is characterized in that the sensor element inserted between a front face of the glow filament and a prestressing element that is welded to the tubular base.

The present invention relates to an apparatus for determining the combustion chamber pressure, and particularly that of combustion engines, and to a method for producing such an apparatus. The invention relates in particular to a pressure measuring glow plug, comprising a tubular body as the housing, a glow pin protruding from the body, and a sensor element disposed in the body for measuring a combustion chamber pressure present at the glow pin. A glow plug having the characteristics described in the preamble of claim 1 is known from WO 2005/114054 A1.

Similar combustion chamber pressure sensors are known, for example, from DE 103 43 521, where a pressure measuring glow plug is described for a diesel engine, comprising a plug body to be inserted in a cylinder of the diesel engine, a heating rod disposed in the plug body, and a pressure sensor disposed between the heating rod and the plug body with prestress such that the pressure present in the combustion chamber of the cylinder is applied to the pressure sensor, wherein the heating rod is disposed displaceably in the plug body in an axially sliding manner and transmits the pressure in the combustion chamber of the cylinder to the pressure sensor.

Furthermore, such a combustion chamber pressure sensor is disclosed in DE 103 46 295, which shows a glow plug comprising a cylindrical housing, the end side of which is located close to a combustion chamber of an engine and which has a threaded section engaged in the engine; a tubular component which is held inside the housing such that the one end side of the tubular component protrudes from the end side of the cylindrical housing; a heat generating component which is located inside the tubular component and generates heat in response to current that is supplied; a metallic center shaft, the one end side of which is electrically connected to the heat generating component and the other end side of which protrudes from the other end side of the housing; and a combustion pressure sensor for detecting a combustion pressure of the engine, which upon generation is transmitted as an axial force acting on the tubular component by way of the center shaft, wherein a section of the center shaft located inside the tubular component has a thermal expansion coefficient of less than or equal to 10.5·10⁻⁶° C.

WO 2007/096208 A1 discloses a pressure-measuring glow plug, wherein a membrane is arranged as a sensor in a sensor cage that is welded to the plug housing. The sensor is coupled to the glow pin by way of a force transmitting element in the form of a sleeve.

DE 10 2005 016 0463 discloses a sheathed element glow plug for a compression-ignition combustion engine, comprising a first module containing a heating body and a plug housing, and a pressure measuring module, wherein the pressure measuring module connects to the first module on a side facing away from the heating body, wherein at least one force measuring element is integrated in the pressure measuring module, wherein the at least one force measuring element is designed to generate an electric signal as a function of a force, and wherein the at least one force measuring element is connected to the heating body such that a force can be transmitted by way of the heating body to the at least one force measuring element.

DE 10 2005 017 802 discloses a sheathed element glow plug for a compression-ignition combustion engine, comprising a heating body and a plug housing, wherein the plug housing comprises at least one force measuring element, wherein the at least one force measuring element is connected to the heating body such that a force can be transmitted by way of the heating body to the at least one force measuring element, wherein the sheathed element glow plug further comprises at least one sealing element connected to the heating body, wherein the at least one sealing element comprises at least one element having an elastic property, and wherein the at least one sealing element seals the heating body with respect to the plug housing.

The disadvantage is that the production of the pressure measuring glow plug requires a complex prestressing process using screws.

It is difficult to mechanically produce the high prestresses that are required, in particular when small dimensions are involved. It is inevitable that the prestress will relax. Compensating for form-related defects of the components is also very difficult.

It is an object of the invention to create an apparatus for determining the combustion chamber pressure and a method for producing a pressure measuring glow plug, wherein the highlighted disadvantages are to be avoided. In particular, a way is to be shown as to how a pressure measuring glow plug can be implemented using a prestressing process which is suited for series production, easy to implement and cost-effective and in which the prestressing force can be adjusted and form-related defects of the components can be compensated for.

This object is achieved by an apparatus having the features given in claim 1 and by a method having the features given in claim 11. Advantageous refinements of the invention are the subject matter of the dependent claims.

A glow plug according to the invention can advantageously be easily assembled in that a sensor element and a prestressing element are introduced in the plug housing formed by a tubular body and a glow pin is inserted in the plug housing. The sensor element is thus disposed between a face of the glow pin and the prestressing element, which is soldered to the plug housing.

Solder can be applied to the prestressing element which is then introduced in the plug housing. In order to solder the prestressing element to the plug housing, preferably only a part of the plug housing against which the prestressing element with the solder rests is heated, thereby melting the solder. During subsequent cooling, the heated part of the plug housing shrinks. In this way, advantageously a prestress that acts on the sensor element can be generated using simple means.

In a glow plug according to the invention, the sensor element is thus clamped between the glow pin and the prestressing element in a well-protected manner in the plug housing. When the combustion chamber pressure changes, thus only the glow pin as such has to be moved to generate a measurement signal. Advantageously, in this way the masses to be moved by the combustion chamber pressure can be kept small with the pressure measuring glow plug according to the invention, which enables an improved measurement.

The sensor element of a glow plug according to the invention is clamped between the face of the glow plug and the prestressing element. The sensor element is therefore subjected to a compressive load between the glow pin and the prestressing element. During operation, the combustion chamber pressure is added to this compressive pressure caused by the prestress. The sensor element, such as a piezo-electric sensor element, supplies an electric signal, the strength of which depends on the pressure that is applied thereto.

One of the advantages of the invention is in particular that it is easy to implement. Pressure measuring glow plugs according to the invention can be produced cost-effectively. In particular, it is also advantageous that the prestressing force can be adjusted by the size of the surface of the plug housing that is heated and the soldering temperature. Any form-related defects of the components that may exist can be compensated for. The present invention can be used advantageously in particular for ceramic glow plugs, however it is also suited for other glow plugs, for example steel glow plugs.

Further details and advantages of the invention will be described based on an exemplary embodiment of the invention, which is illustrated in the attached drawings. In the drawings:

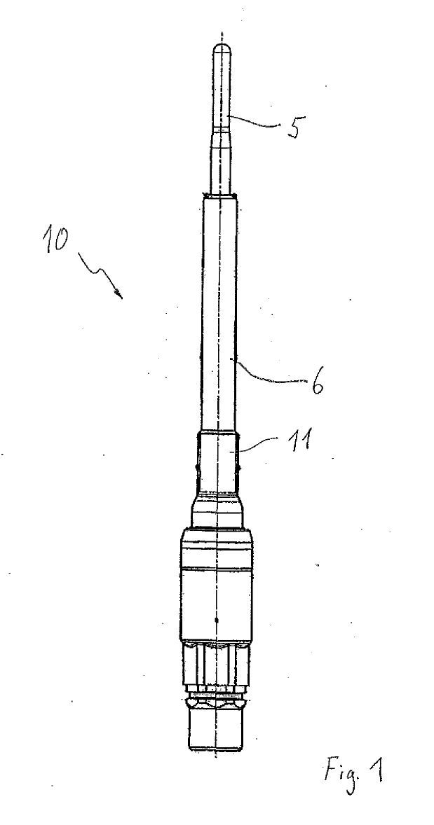

FIG. 1 is an exemplary embodiment of a pressure measuring glow plug according to the invention;

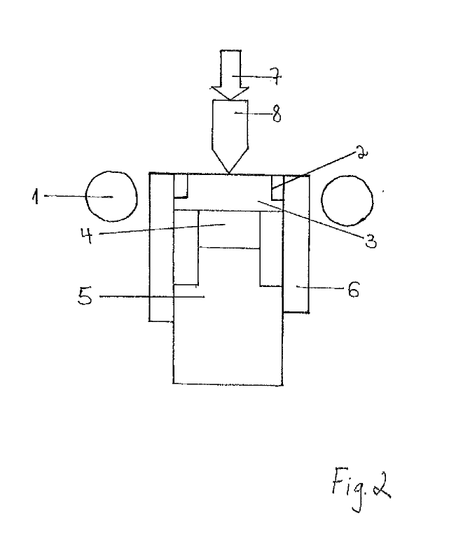

FIG. 2 is a schematic view of the production method for the pressure measuring glow plug illustrated in FIG. 1.

FIG. 1 shows an exemplary embodiment of a pressure measuring glow plug. The pressure measuring glow plug 10 shown comprises a tubular body 6 as the housing, a glow pin 5 protruding from the body. The housing has an external thread 11 for screwing the plug into a threaded bore of a diesel engine. The glow pin 5 can be moved in the axial direction in the tubular body 6. The higher the combustion chamber pressure, the further the glow pin 5 is consequently pushed into the tubular body 6 and compresses a sensor element which is disposed in the body 6 and shown in FIG. 2.

FIG. 2 illustrates the method for producing such an apparatus for determining the combustion chamber pressure based on a schematic detailed view of the inner design of the pressure measuring glow plug.

The tubular body 6 illustrated in FIG. 2 encloses the rod-shaped glow pin 5. A sensor element 4 is fixed or supported on the end face of the glow pin 5 located in the body so as to measure a pressure that is applied to the glow pin 5. The sensor element 4 is preferably a piezo-electric sensor element, for example in the form of a disk. A prestressing element 3 having solder 2 at the lateral surface is introduced in the body 6 and placed on the sensor element 4. Optionally a pressing pressure 7 is applied to the prestressing element 3 by way of a pressing pin 8 in order to overcome the friction at the lateral surface, so that the prestressing element 3, the sensor element 4, and the glow pin 5 have a better fit with respect to each other.

As is shown in FIG. 2, the tubular body 6 is disposed concentrically around the glow pin 5, the sensor element 4, and the prestressing element 3. As a result, an annular space is formed between the sensor element 4 and the tubular body 6.

The prestressing element 3 preferably has a lateral recess, which is filled with hard solder 2. In the embodiment shown, the lateral recess is formed by the prestressing element 3 having a reduced diameter on the side thereof facing away from the sensor element 4. The annular space formed in this way between the tubular body 6 and the prestressing element 3 is filled with solder 2.

A part of the body is heated at the level of the active solder 2 by way of the heat source 1. The active solder 2 and the region of the body 2 located in the vicinity thereof are likewise heated by heat conduction or convection. When the temperature at the solder 2 reaches the melting temperature, the solder 2 liquefies and the prestressing element 3, as a result of the dead weight thereof, either falls onto the sensor element 4 without pressing pressure 7 or is pressed onto the sensor element 4 by way of a pressing pressure 7.

The pressing pin 8 is provided with a pointed contact surface, so that with pressing pressure 7 the prestressing element 3 is seated on the sensor element 4 with zero backlash and the sensor element 4 is seated on the glow pin 5 with zero backlash.

The entire system cools down when the heating phase has ended. The prestress on the sensor element 4 is created as a result of the shrinkage of the heated part of the body 6. The amount of the prestress can be adjusted by way of the position and size of the heated surface of the body 6 and the soldering temperature.

The sensor element 4 and the prestressing element 3 may have a passage, such as a borehole, through which a connection for the glow pin 5 is guided. The connection may be a metallic rod, for example, which is placed through the sensor element 4 and the prestressing element so as to contact the inner conductor of the glow pin 5. As an alternative, the connection may also be a strand. The connection is preferably soldered to the inner conductor. This can be carried out together with the above-described soldering of the prestressing element 3 to the body 6 or in a subsequent step.

### REFERENCE NUMERALS

1 Heat source
2 Solder
3 Prestressing element
4 Sensor element
5 Glow pin
6 Tubular body
7 Pressing pressure
8 Pressing pin
10 Glow plug
11 Thread

1-15. (canceled)

16. An apparatus for determining combustion chamber pressure, said apparatus comprising:
a tubular body,
a glow pin protruding from the tubular body;
a prestressing element, disposed in the tubular body; and
a sensor element disposed in the tubular body, said sensor element being clamped between a face of the glow pin and the prestressing element.

17. The apparatus for determining the combustion chamber pressure according to claim 16, wherein the sensor element rests against the face of the glow pin.

18. An apparatus for determining the combustion chamber pressure according to claim 16, wherein the prestressing element is disposed entirely in the tubular body.

19. An apparatus for determining the combustion chamber pressure according to claim 16, wherein an annular space is formed between the sensor element and the tubular body.

20. An apparatus for determining the combustion chamber pressure according to claim 16, wherein the prestressing element rests against the tubular body with a lateral surface.

21. An apparatus for determining the combustion chamber pressure according to claim 16, wherein the prestressing element has a lateral recess which is filled with solder.

22. An apparatus according to claim 16, wherein the prestressing element has a reduced diameter at the side thereof facing away from the sensor element and in this way an annular space formed between the tubular body and the prestressing element is filled with solder.

23. An apparatus for determining the combustion chamber pressure according to claim 16, wherein the sensor element has a passage through which a connection of the glow pin is guided.

24. An apparatus for determining the combustion chamber pressure according to claim 16, wherein the sensor element is surrounded concentrically by the tubular body.

25. An apparatus for determining the combustion chamber pressure according claim 16, wherein the apparatus is a glow plug, the housing of which is formed by the tubular body.

26. A method for producing an apparatus according to claim 16, comprising the following steps:
arranging a sensor element in a tubular body between a face of a glow pin and a prestressing element which is disposed in the tubular body and provided with solder, and
melting the solder by heating the zone of the prestressing element provided with solder,
wherein a section of the tubular body is heated so as to melt the solder and a prestress acting on the sensor element is generated by shrinking the heated section during cooling.

27. The method according to claim 26, wherein the amount of the prestress is adjusted by way of the position and size of the heated surface of the body.

28. The method according to claim 27, wherein a pressing pressure is applied to the prestressing element by way of a pressing pin.

29. A method according to claim 26, wherein a pressing pressure is applied to the prestressing element during heating.

30. A method according to claim 26, wherein the solder is applied to a lateral surface of the prestressing element and thereafter the prestressing element is introduced in the body.
